(19) United States
(12) Patent Application Publication
(10) Pub. No.: US 2025/0278720 A1
(43) Pub. Date: Sep. 4, 2025

(54) Method for allocating money from a bank account to an anonymous unidentified person and cardless unidentified anonymous ATM cash withdrawal

(71) Applicant: Meir Dahan, Tiberias (IL)

(72) Inventor: Meir Dahan, Tiberias (IL)

(21) Appl. No.: 19/178,943

(22) Filed: Apr. 15, 2025

Related U.S. Application Data
(63) Continuation-in-part of application No. 18/143,068, filed on May 4, 2023.

(51) Int. Cl. G06Q 20/38; G06Q 20/10; G06Q 20/16; G06Q 20/40

(52) U.S. Cl. CPC G06Q 20/383; G06Q 20/1085; G06Q 20/16; G06Q 20/385; G06Q 20/405

(57) ABSTRACT

A method for allocating money from a bank account to an unidentified, anonymous person and for enabling a cardless, unidentified, and anonymous ATM cash withdrawal, including the steps of receiving allocation requests from bank account holders via online bank accounts, each request including an allocated amount and an associated non-registered mobile phone number, storing the requests in a bank database, flagging each allocation request as authorized for cardless, unidentified, and anonymous withdrawal, to be completed solely by entry at an ATM of the specified phone number and a one-time password (OTP) sent to that number, and authorizing the cash withdrawal of the allocated amount.

### RELATED APPLICATIONS

This application is a continuation in part of U.S. patent application Ser. No. 18/143,068 filed on May 4, 2023.

### TECHNICAL FIELD

The present invention refers to a method for allocating money from a bank account to an anonymous, unidentified person and for enabling a cardless, unidentified, and anonymous cash withdrawal of the allocated money via an Automated Teller Machine (ATM).

### BACKGROUND ART

In many cases people prefer to receive money in cash instead of receiving it to their bank account. This does not mean that it is an illegal receipt of money or a desire to avoid reporting to the tax authorities, rather, this need sometimes stems from an approach that advocates personal freedom not to be tracked and also from a desire to avoid the need to give legitimate explanations for receiving funds legally that there was no legal obligation to report them, which involves in expense and trouble, and to avoid the need to give such explanations there is interest in receiving sums of money in cash without leaving digital traces of the receipt of that money. In many cases, the person who supposed to receive the money is in a distant place from the person who supposed to give the money, so handing over money in cash from hand to hand is not practical. The present invention provides a good solution to this problem, as well as other problems of transferring money to friends or family members who have lost their wallet and needs urgent cash when they are in distance.

### DESCRIPTION OF THE DRAWINGS

The intention of the drawings attached to the application is not to limit the scope of the invention and its application. The drawings are intended only to illustrate the invention and they constitute only one of its many possible implementations.

FIG. 1 is a block diagram that depicts the system (1) with the bank server (2), the processors (processing devices) (10), the automated teller machine ATM (3), the computing device (5), the mobile phone (6) and the computer application (4).

### THE INVENTION

The main objective of the present invention is to provide a computer-implemented method for allocating money from a bank account to an anonymous, unidentified person and for enabling a cardless, unidentified, and anonymous cash withdrawal of the allocated money via an Automated Teller Machine (ATM). The method includes one or more of the following means and steps:

Receive, by a bank server, allocation requests transmitted over a telecommunication network (7). Each allocation request is originating from a bank account holder via an online banking account interface (51). The allocation requests comprising an allocated amount of money, a non-registered mobile phone number, and instructions to authorize cardless, unidentified, and anonymous ATM cash withdrawal of the allocated amount.

The term “a bank server” refers also to a multiple or a plurality of bank servers, including servers of third parties providing services to the bank, such as for generating, sending, and verifying One Time Passwords (OTP). The term “pending” refers to allocation requests and/or allocated amounts that have not yet been withdrawn. The term “bank account” in this disclosure and the claims means any kind of account that enables the owner to withdraw cash from ATMs with or without a card.

Automatically flag within the bank server each allocation request, as authorized for cardless, unidentified, and anonymous ATM cash withdrawal of a respective allocated amount, by pre-stored machine-readable instructions. The authorization is valid solely upon manual entry, at an ATM, of a mobile phone number associated with the corresponding allocation request and a one-time password (OTP) sent by the bank server to the associated mobile phone number. The term “flag” or “flagging” refers to the act of marking or identifying something for special attention or further processing. In technical and banking contexts, it means setting a digital indicator (a flag) in a system to signal a particular status, condition, or action to be taken-such as flagging a transaction for review, security, or special handling.

Store the flagged allocation requests in a database, including the instructions to authorize cardless, unidentified, and anonymous ATM cash withdrawal of the allocated amounts.

Maintain the database with the stored flagged allocation requests pending execution.

Receive, by the bank server, a manual entry of a mobile phone number transmitted from an ATM over a telecommunication network (7) during a process of cardless, unidentified, and anonymous ATM cash withdrawal. At this stage, the anonymous person, who is in fact the recipient of the money, the person to whom the bank account holder allocated the money, needs only to approach an ATM, enter the mobile phone number (that can be unregistered number in the bank and unregistered at all) and starts the process of the anonymous cardless withdrawal. The ATM is programmed to transmit this entry of such mobile phone number to the bank server.

Automatically match, by the bank server, the entered mobile phone number received from the ATM with a mobile phone number associated with a pending flagged allocation request stored in the database using matching-executed comparison logic (21).

Generate, by the bank server (that is likely to be a third party server that provides such service), a one-time password (OTP) and send this OTP to the matched mobile phone number.

Receive, by the bank server, a manual entry of the OTP transmitted from the ATM over the telecommunication network (7). In this stage, the anonymous person needs simply to enter to the ATM the OTP received to the mobile with the SIM associated with that mobile phone number for continuing the process of the withdrawal. The ATM is programmed to send this entry of the OTP to the bank server.

Automatically match, by the bank server or the ATM, the entered OTP with the sent OTP using matching-executed comparison logic (21).

Receive, by the bank server or the ATM, a manual entry of a requested withdrawal amount that is equal to or less than an allocated amount associated with the matched mobile phone number and stored in the database. At this stage, the ATM may display the allocated amount (or the remaining allocated amount that has not yet been withdrawn), and the person is required to either input the amount to be withdrawn or proceed with the displayed amount.

Automatically authorize, by the bank server or the ATM, based on machine-executed verification of matched allocation data, the cardless, unidentified, and anonymous ATM cash withdrawal of the requested amount.

In this disclosure and the claims, the term “anonymous person” refers to an individual about whom nothing is known. The term “anonymous withdrawal” means a withdrawal carried out by such an anonymous person-someone with no known personal or identifying information. The term “unidentified person” refers to an individual whose identifying details were not received, either during the collocation request or the ATM withdrawal process. Accordingly, the expression “unidentified withdrawal” refers to a withdrawal performed by an unidentified person.

One of the most inventive aspects of the present invention lies in how the various elements cooperate in a specific and non-obvious way to achieve something new and useful: secure, anonymous, cardless, and IDless (unidentified) ATM withdrawals, using non-registered phone numbers and bank-controlled, conditional OTP logic. This coordination is unconventional and not part of the prior art.

The present invention discloses technical effects related to allocating money from a bank account to an anonymous, unidentified person and enabling a cardless, unidentified, and anonymous cash withdrawal of the allocated money via an ATM. It includes specific technical implementations, such as flagging the allocated requests to authorize cardless, anonymous, and IDless ATM cash withdrawals.

The effect of this invention is to facilitate a new kind of ATM interaction, where an anonymous, unidentified, cardless individual can withdraw cash, as well as a new form of secure peer-to-peer transfer of money from a bank account to an unidentified, anonymous, and unregistered person.

The application of the pre-stored machine-readable instructions enables the ATM to execute withdrawals of the allocated amounts without accessing, verifying, or storing personal identity data of persons performing the withdrawals.

The invention makes the allocated amounts of the flagged allocation requests available for cardless, unidentified, anonymous cash withdrawal via ATM by an unregistered individual solely by manual entry of the specified non-registered mobile phone number and the one-time password (OTP) sent thereto, along with an input of a requested amount, without processing or requiring personal identity data of a person performing the withdrawal from the bank account holders and from the ATM during the withdrawal process.

The withdrawal is performed solely through a predefined input sequence at the ATM, the sequence comprising manual entry of the specified mobile phone number, the OTP, and the requested amount, and enabling the withdrawal without requiring, processing or processing personal identity data of the person performing the withdrawal by either the ATM or the bank server.

For clarity, the term “IDless” and “unidentified” as used in this disclosure and in the claims refers to a withdrawal in which no personal identification step is required at any point during the process, including submitting the allocation request, storing the request, and processing the withdrawal. The person performing the withdrawal is never required to identify themselves. The only information needed is the manual entry of the specified phone number and the OTP sent to that number.

The method may be performed by processors (processing devices) (10) running on one or more servers (2) and one or more automated teller machines ATM (3) that are programed to function and used for executing the method. The method may include the following steps and means, as stated above, and explained here below in a different angle:

This step is optionally, but in any case the owner should use the relevant computer application (which is likely to run under the consent of the bank): Receiving, by the one or more servers (2) from a computing device (5) of the bank account owner (holder), a request to login to a computer application (4) (in which the bank account owner have an online bank account). The term “login” in this disclosure and in the claims means also to “logon” and therefore the request to login to the computer application may include the need to provide one or more security feature submitted by the owner of the bank account such as a password, a PIN, or a biometric as it is customary in this filed.

The term “computing device” (5) in this disclosure and in the claims means any kind of computer that includes an internet access, such as a smartphone, a mobile phone, a tablet, laptop, desktop and the like. The term “computer application” (4) literally means computer software applications that enable users and owners of bank accounts to operate their account in an online manner. The term “the computing device (5) of the owner” means the device that he uses for entering the computer application.

This step is optionally, but in any case the owner should insert some identification to ensure that it is he that makes the request): Granting, by the one or more servers, authorization to said computing device of the owner to access to the computer application. The access to the computer application (or the completion of the request) may be in response to verifying that the submitted security feature match the profile security feature stored in the user profile in the server that run the computer application, as customary done when a person wishes to login to his account by a computer or to wire money to a third person.

Receiving, by the one or more servers, a request from the online account of the bank account owner, by means of said computer application, to allocate the certain amount of money to the third party recipient so that he become authorized and able to make the cardless and IDless withdrawal in cash of the allocated certain amount of money from an automated teller machine ATM upon entering said specific mobile phone number at the relevant automated teller machine ATM. It is possible that the recipient will withdraw the money in a few withdrawals that in total are limited to that certain amount of money. Each cardless withdrawal requires an input in to the automated teller machine ATM of the specific mobile phone number that the bank account owner specified as part of the request to allocate the amount of money to the third party recipient.

The computer application enables to set the amount of money that the owner wants to enable that third person to withdraw in cash from his bank account (by using the ATM) and the specific mobile phone number of that recipient (no need to give or get specific passwords in this stage for executing the withdrawal). The bank account owner may need to add nothing beyond that. The owner should enter to the computer application the phone number of the recipient and the certain amount of money (and maybe to tap “Done” or “Send”) and by that he sends the request. The computer application may be designed in a way that it will enable the owner to determine whether the allocation of said money is reversible or irreversible. “Reversible” means that that the request to enable the withdrawals limited to the certain amount of money can be canceled as to the part of the certain amount of money that yet was not withdrawn at that moment of cancelation of the request, and determining by the one or more servers that said request is reversible; “Irreversible” means that the request to enable the withdrawal in cash of the certain amount of money cannot be canceled at all, and determining by the one or more servers that said request is irreversible. So, when recipient receives the message that the certain amount is irreversible he can see it as a certain amount that fully paid to him and not on a condition.

It is understood that the owner should enter a specific mobile phone number that is possessed by the third party recipient that he wishes to enable him to make the cardless withdrawal (or with access to that specific mobile phone number), and the owner knows that the method includes the step (the need) of the recipient to enter OTP phone verification that will be sent as SMS for example to the mobile phone with a SIM of that mobile phone (6) number of the recipient using that phone number. When recipient wishes to get money without tracing he can buy a sim without providing identification, which is legal at many democratic countries as part of the personal freedom.

The computer application may be designed in a way that it will enable the owner to determine whether the allocation of said money can be canceled (reversible allocation) or whether from the moment he approves the allocation then it cannot be returned (irreversible allocation). Also, it is possible and desirable that, immediately after the allocation is made, the system that operates this method will send a message to the mobile phone number of the recipient informing him that the owner has allocated to him that certain amount of money and that the allocation can be canceled (revisable), or cannot be canceled (irreversible), and it is possible that the message (SMS) will include a period of time within he must withdraw the money otherwise the allocation will be canceled automatically (this for cases in which the recipient lost his sim with that mobile phone number for example).

Receiving, by the automated teller machine ATM, (an entry) the input of the specific mobile phone number that is required in order for enabling (authorizing) the cardless withdrawal in cash. In this step, when the recipient wishes to withdraw in cash the money then he needs to enter his specific mobile phone number into the automated teller machine ATM. The existing automated teller machines ATM are fit for this mission if updating their program operation, such as, by adding an option to press a button or to tap on their touch screens to select option to withdraw by phone number for example.

In response to the input of the specific mobile phone number in to the automated teller machine ATM, the one or more servers generate and transmit to the specific mobile phone number (to the mobile device in which the sim of this number is activated) an SMS or another type of message with the onetime password OTP (similar to phone verification). The fact that the OTP that enables the withdrawal is generated and transmitted a moment of the withdrawal and directly to the recipient is an important part and it is an effective protection mechanism.

Receiving, by the automated teller machine ATM, the input of the onetime password (OTP), means that the recipient needs to enter at the automated teller machine ATM the OTP for completing the withdrawal.

Verifying, by the one or more servers or by the automated teller machine ATM, the onetime password (OTP) that was input in to the automated teller machine ATM matches the generated onetime password (OTP). The match can be done for example in the automated teller machine ATM itself (means that the one or more servers send the OTP also the automated teller machine ATM) or on the one or more servers. The verification can be done by comparing the entered OPT with the generated OTP, in the one or more servers, the automated teller machine ATM, or in a database located in the one or more servers.

Before verifying the OTP or before authorizing the cardless withdrawal, it is desirable that the one or more servers will determine whether the withdrawn amount (together with other withdrawals done before) do not exceed the limited certain amount of money.

authorizing and enabling, by the one or more servers or by the automated teller machine ATM, the withdrawal in cash upon said verification. In general, authorization means that the automated teller machine ATM enables the withdrawal.

The bank can charge the bank account of the owner for the allocated certain amount at any time and in several ways, for example: in the case of an irrevocable (irreversible) allocation, the bank can charge the bank account of the owner at the moment of the allocation for the entire allocation amount, or lock the allocation amount so that it will no longer be available for use by the bank account owner and will charge the account upon the withdrawals in fact. It is possible to charge the bank account after each withdrawal. The manner and time of the charge can be made in several dates and ways.

In other words, the request to allocate the certain amount of money can be reversible, and in this case the servers or the computer applications enable the bank account owner to cancel the allocation. Another option of the method, the request to allocate the certain amount of money cab be irreversible, and in such case the servers or the computer applications limiting the bank account owner to cancel the allocation (means, that in the regular standard options the owner is disabled from having the option to cancel such irreversible allocation, but he may have the option to do so throng a specific request that will be decided by a representative of the credit card company in a certain special cases). In response to irreversible request, the method may send a message to the specific mobile phone number stating that the allocation of the certain amount of money is irreversible.

The method can be designed to enable the recipient to withdraw a part of the money, and he can withdraw the balance at another time. Also, the method can be designed to enable to include the possibility that in case that several amounts have been assigned (allocated) to the same phone number by several people (bank account owners), then the details of the senders can be displayed on the automated teller machine ATM's display (when inserting the OTP) and the recipient will be given the option to choose from whom to withdraw and how much (with limited to the allocated amount from that person/owner). It is possible and desirable that after each withdrawal, both the bank account owner and the recipient will receive a message from the servers informing them that a withdrawal has been approved for x amount and that the remaining balance for withdrawal is y for example.

The method can be executed by the system (1) and another objective of the present invention is to provide the computer system for enabling the owner of the bank account to allocate a certain amount of money to a third party recipient, such that the third party recipient is authorized and enabled to (cardless) withdraw in cash the allocated certain amount of money from automated teller machine ATM (3). The third party recipient is able and authorized to make the cardless withdrawal from the automated teller machine ATM by input a specific mobile phone number that the owner sets in the request for allocation the certain amount of money from the automated teller machine ATM. In general the parts of the system are same to the parts and steps of the method and there is no need to repeat theme.

The communications means and methods between the computing devices, the servers, the automated teller machines ATM, the computer application, are known to experts in the field and therefore there is no need to describe them in this disclosure.

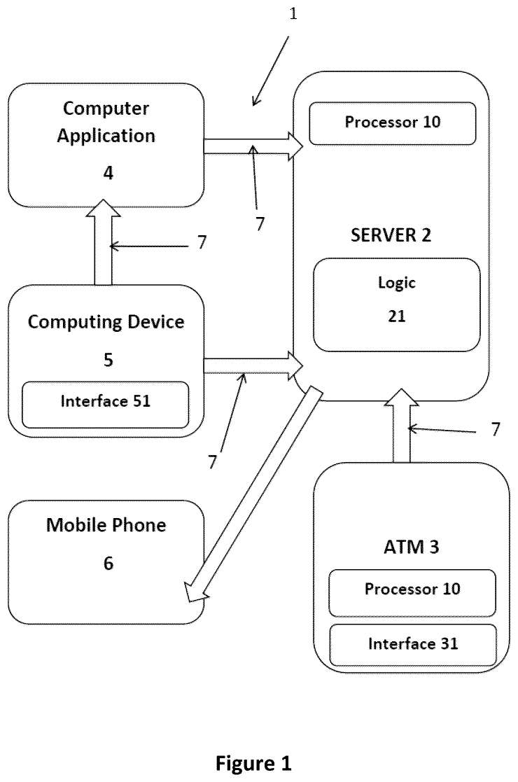

FIG. 1 is a block diagram that schematically depicts the system (1) with the servers (2), the processors (processing devices) (10), the automated teller machine ATM (3) with its user interface and input mechanism (31) for entering the specific mobile phone number and the OTP, the computing device (5) of the bank account holder/owner, the mobile phone with the SIM (6) of the recipient and the computer application (4).

1. A computer-implemented method for online authorization, over a telecommunication network, of a cardless cash withdrawal via an Automated Teller Machine (ATM) by an unidentified and anonymous person using allocated money from a bank account holder, the method comprising:
receiving, over a telecommunication network, by a bank server, allocation requests for anonymous cash withdrawals transmitted by bank account holders via an online bank account interface, each allocation request comprising an allocated amount of money, a non-registered mobile phone number, and instructions to authorize a cardless cash withdrawal of the allocated amount via an ATM by an unidentified; and anonymous person;
automatically flagging, by execution of pre-stored machine-readable instructions within the bank server, each allocated amount as authorized for cardless withdrawal by an unidentified and anonymous person via ATM, conditioned on fulfillment of a sufficient requirement comprising manual entry, at an ATM, of a mobile phone number linked to a corresponding allocated amount and a one-time password (OTP) transmitted by the bank server to the linked mobile phone number;
storing the flagged allocation requests in a database, including the instructions to authorize cardless withdrawals of the allocated amounts by unidentified and anonymous persons via an ATM;
maintaining the database with the stored flagged allocation requests pending execution;
receiving, over a telecommunication network, by the bank server, a manual entry of a mobile phone number transmitted from an ATM during a process of cardless withdrawal by an unidentified and anonymous person via the ATM;
automatically matching, within the bank server, the entered mobile phone number received from the ATM with a mobile phone number associated with a pending flagged allocation request stored in the database using machine-executed comparison logic;
generating, by the bank server, a one-time password (OTP) and sending the OTP to the matched mobile phone number;
receiving, over a telecommunication network, by the bank server, a manual entry of the OTP transmitted from the ATM;
automatically matching, within the bank server or the ATM, the entered OTP with the sent OTP using machine-executed comparison logic;
receiving, by the bank server or the ATM, a manual entry of a requested withdrawal amount that is equal to or less than an allocated amount associated with the matched mobile phone number and stored in the database; and
automatically authorizing, by the bank server or the ATM, based on machine-executed verification of matched allocation data, the cardless withdrawal of the requested amount by an; unidentified; and anonymous person via the ATM, conditioned on fulfillment of the sufficient requirement comprising the manual entry of the matched mobile phone number and the OTP.
